(19) United States
(12) Patent Application Publication
(10) Pub. No.: US 2026/0209887 A1
(43) Pub. Date: Jul. 23, 2026

(54) METHOD AND APPARATUS FOR METALS RECOVERY

(71) Applicant: FLASH METALS USA INC., Houston, TX (US)

(72) Inventors: Clifton T. KNIGHT, League City, TX (US); Aaron KNIGHT, League City, TX (US); Luis RODRIGUEZ, Katy, TX (US); David CARPENCY, Webster, TX (US); Steven RAGIEL, Houston, TX (US)

(21) Appl. No.: 19/449,770

(22) Filed: Jan. 15, 2026

Related U.S. Application Data
(60) Provisional application No. 63/101,198, filed on Jan. 22, 2025.

(51) Int. Cl. C22B 7/00; C01D 15/04; C22B 1/248

(52) U.S. Cl. CPC C22B 7/002; C01D 15/04; C22B 1/248

(57) ABSTRACT

A metal treatment process may include crushing or grinding a metal-containing feedstock and heating the metal-containing feedstock in an inductive heating reactor or inductive/ohmic heating reactor.

### CROSS-REFERENCE TO RELATED APPLICATIONS

This application is a nonprovisional application which claims priority from U.S. provisional application number 63/101,198, filed Jan. 22, 2025, which is incorporated by reference herein in its entirety.

### TECHNICAL FIELD/FIELD OF THE DISCLOSURE

The present disclosure relates generally to processing of materials containing metals.

### BACKGROUND OF THE DISCLOSURE

There are many different traditional methods of separating metals from such starting materials as ores, mine tailings, manufacturing and production scrap and waste streams and recycle streams, electronic waste, and black mass. These traditional methods are often low efficiency in that much of the metal may be left in the starting materials. Traditional methods consume significant amounts of energy, acid/base reagents, and water, being environmentally toxic. Thus, such traditional methods may result in valuable metals being unrecovered and toxic ending materials.

### SUMMARY

The disclosure includes a metal treatment process. The metal treatment process may include crushing or grinding a metal-containing feedstock and heating the metal-containing feedstock in an inductive heating reactor or inductive/ohmic heating reactor to separate a metal from the feedstock.

The disclosure also includes a metal extraction process. The metal extraction process may include crushing or grinding a metal-containing feedstock and combining the feedstock with a halogen gas. The process may also include reacting the metal-containing feedstock in an inductive heating reactor or inductive/ohmic heating reactor to form a metal halide.

In addition, the disclosure includes a semi-batch reaction system. The semi-batch reaction system includes a reactor loading hopper and one or more inductive heating reactors or inductive/ohmic heating reactors in fluid connection with the reactor loading hopper. The semi-batch reaction system also includes an outgassing manifold, the outgassing manifold in fluid connection with the one or more inductive heating reactors or inductive/ohmic heating reactors.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block flow diagram of a metals treatment process consistent with certain embodiments of the present disclosure.

FIG. 2 is a block flow diagram of a metals removal process consistent with certain embodiments of the present disclosure.

FIG. 3A is a side view of a portion of a semi-batch reactor system consistent with certain embodiments of the present disclosure.

FIG. 3B is a perspective view of the portion of a semi-batch reactor system shown in FIG. 3A.

FIG. 4A is a cross-sectional view of an inductive heating reactor consistent with certain embodiments of the present disclosure.

FIG. 4B is a close-up view of the inductive heating reactor of FIG. 4A.

FIG. 5A is a cross-sectional view of an inductive/ohmic heating reactor consistent with certain embodiments of the present disclosure.

FIG. 5B is a close-up view of the inductive/ohmic heating reactor of FIG. 5A.

FIGS. 6A-6C illustrate process steps of heating reactor consistent with certain embodiments of the present disclosure.

FIG. 7A is a perspective view of an outgassing manifold consistent with certain embodiments of the present disclosure.

FIG. 7B is a close-up view of a portion of the outgassing manifold of FIG. 7A.

FIG. 8 is a cross-sectional view of a continuous inductive heating reactor consistent with certain embodiments of the present disclosure.

FIG. 9 is a perspective view of downstream washing unit consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In certain embodiments of the present disclosure, a metal extraction process is described that uses inductive heating or inductive and ohmic heating to convert target metals in a feedstock, such as ore, electronic waste, or black mass, into gaseous form. The metal extraction process may be continuous or semi-batch operations. In some embodiments using the metal extraction process, heat transfer and fluidization mechanisms may be used to achieve efficient reaction kinetics. In some embodiments, the feedstock may be combined within a reactor that uses inductive heating or inductive and ohmic heating with a halogen gas, such as fluorine or chlorine. In some embodiments, additives may be introduced to control the reaction. For example, carbon may be used as an oxygen-reducing agent for highly stable compounds. Examples of such carbon include carbon black or carbonized products such as carbonized wood chips or carbonized coconut hulls. In some embodiments, silicon may be used for retarding the formation of certain products.

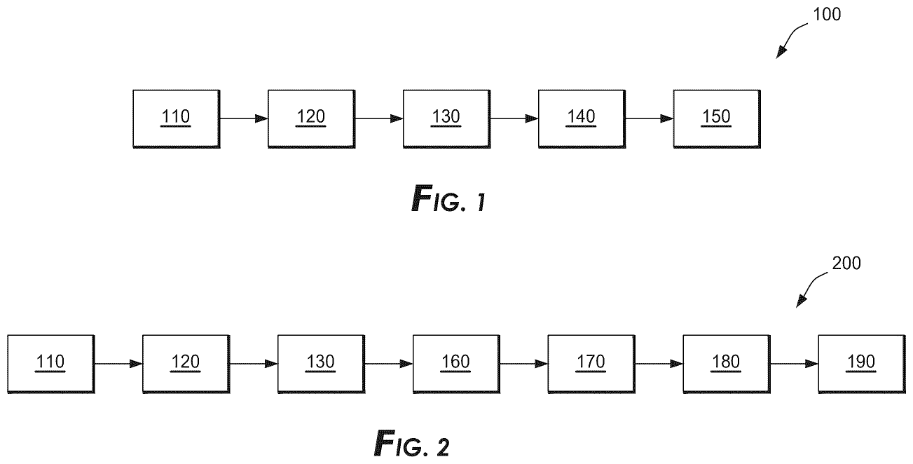

FIG. 1 is a block flow diagram of metal treatment process 100. In certain embodiments, a feedstock containing a metal may be introduced to metal treatment process 100. Examples of such feedstocks may include ores, electronic waste, black mass, lanthanide concentrate, spodumene, bauxite residue (for example, red mud), coal fly ash, gold tailings, rare earth element tailings and fines, and production scrap from processes utilizing indium, gallium, or germanium. As used herein, “black mass” refers to material recovered from end-of-life lithium-ion batteries during recycling. For example, rare earth element tailings and fines may be formed in mining and concentrating of rare earth bearing minerals, such as, for example and without limitation, bastnasite, monazite, ionic clay, and eudialyte. Such rare earth tailings and fines may include between, for example, 200 ppm and 25% by weight of a rare earth element, such as terbium, dysprosium, neodymium, Praseodymium, and scandium. In some embodiments, the feedstock may be crushed or ground to increase surface area of the feedstock in feedstock grinding step 110 to form ground feedstock. In some embodiments, the ground feedstock may be dried in feedstock drying step 120 to form a dried feedstock. As one of ordinary skill in the art with the benefit of this disclosure will appreciate, feedstock drying step 120 and feedstock grinding step 110 may be reversed. In certain embodiments, feedstock grinding step 110, feedstock drying step 120, or both may be omitted.

Following either feedstock drying step 120 or feedstock grinding step 110 when used, the dried feedstock or ground feedstock may be fluidized, such as in a semi-batch reactor, or combined with a carrier fluid, such as in a continuous reactor in combine with carrier/fluidize step 130. The fluidization medium or carrier fluid may be any suitable material, for example and without limitation, argon. Following fluidization or combination with a carrier, the ground and dried feedstock may be heated in an inductive heating reactor or inductive/ohmic heating reactor in heat reactants step 140. Ohmic heating may also be described as flash Joule heating. In heat reactants step 140, the reactor may be heated through inductive heating or a combination of inductive and ohmic heating to a temperature range that causes metals in an acid-resistant or otherwise resistant state to break up and form a less-acid-resistant compound. Metals in this acid-resistant state may be sourced, for example and without limitation, from a refractory. Without being bound by theory, the resulting metal compound may be an oxide or other acid-penetrable form. The metal may then be cooled and recovered in cooling step 150.

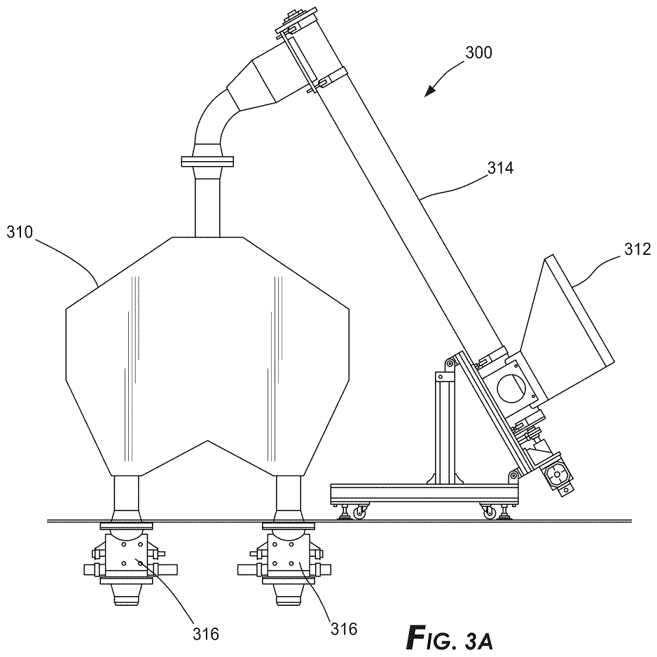

FIG. 2 depicts metal extraction process 200. In certain embodiments of metal extraction process 200, a feedstock containing a metal may be introduced. Examples of such feedstocks may include ores, electronic waste, black mass, lanthanide concentrate, spodumene, bauxite residue (for example, red mud), coal fly ash, gold tailings, rare earth element tailings and fines, and production scrap from processes utilizing indium, gallium, or germanium. For example, rare earth element tailings and fines may be formed in mining and concentrating of rare earth bearing minerals, such as, for example and without limitation, bastnasite, monazite, ionic clay, and eudialyte. Such rare earth tailings and fines may include between, for example, 200 ppm and 25% by weight of a rare earth element, such as terbium, dysprosium, neodymium, Praseodymium, and scandium. As used herein, “black mass” refers to material recovered from end-of-life lithium-ion batteries during recycling. In some embodiments, the feedstock may be crushed or ground as described above or these steps may be omitted.

Following either feedstock drying step 120 or feedstock grinding step 110 when used, the dried feedstock or ground feedstock may be fluidized, such as in a semi-batch reactor, or combined with a carrier fluid, such as in a continuous reactor in combine with carrier/fluidize step 130. The fluidization medium or carrier fluid may be any suitable material, for example and without limitation, a halogen gas, a noble gas such as argon, or a combination thereof. Following fluidization or combination with a carrier, the ground and dried feedstock may be heated and reacted with a halogen gas and metal to form gaseous metal halides in reaction step 160. Without being bound by theory, this reaction may proceed as follows, with chlorine shown as a non-limiting example of a halogen gas:

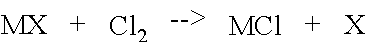

As a specific example, when reacting spodumene with chlorine gas:

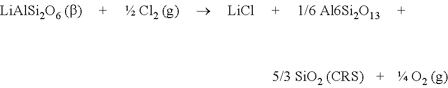

Reaction step 160 may be performed continuously or semi-batch. Reaction temperature may be controlled, for example, based on the metal to be recovered. For example, certain feedstocks may include multiple metals. Because different metals react with the halogen gas in different temperature ranges, in certain embodiments, the reaction temperature may be adjusted to a first temperature reaction range, for example, to capture a first metal and then adjusted to a second temperature reaction range to capture a second metal. In others, multiple reactors may be used and may operate at different temperature ranges. By operating in a certain temperature ranges high value metals may be selected while minimizing non-targeted reactions. As non-limiting examples, metals such as aluminum, magnesium, and lithium form metal halides at approximately 250° C. In contrast, more thermally stable metals, such as titanium and tantalum, may require higher temperatures, such as about 1800° C. for halogenation.

In both semi-batch and continuous reaction, after reaction step 160, metal halide off gas may be captured in metal halide off gas capture 170. The metal halides may be washed in metal halide wash 180 and condensed in brine condensation 190.

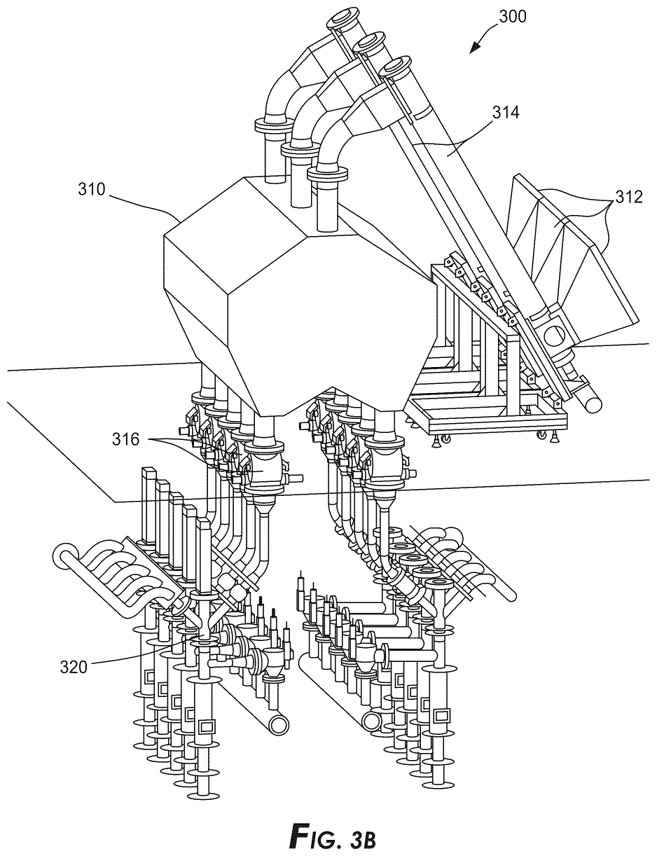

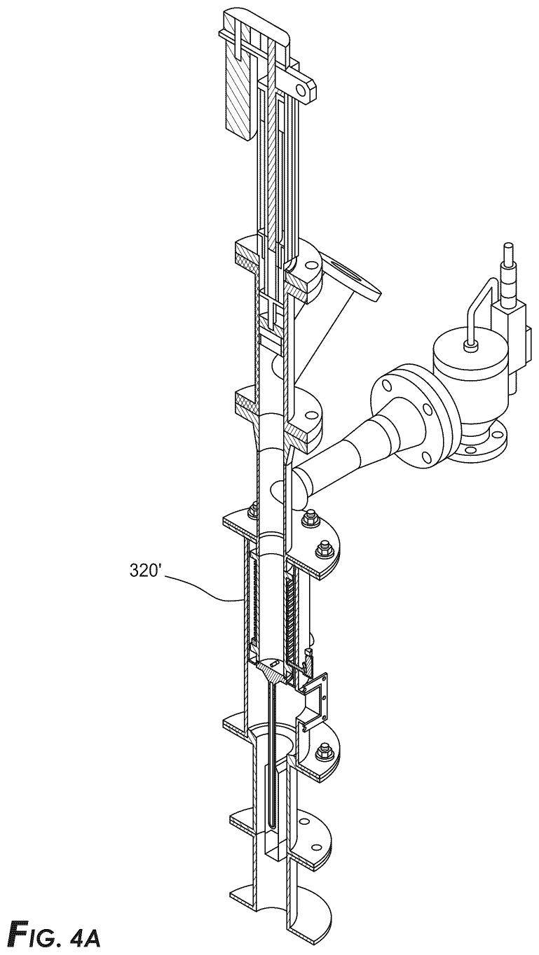

FIGS. 3A and 3B depict examples of semi-batch reactor system 300 in accordance with certain embodiments of the present disclosure in which a reaction between the metal and the halide may occur. Semi-batch reactor system 300 may include reactor loading hopper 310. Reactor loading hopper 310 is adapted to contain and deliver feedstock containing metal to one or more reactors 320 to which reactor loading hopper 310 is fluidly connected as shown in FIG. 3B. One or more feed hoppers 312 may be fluidly connected to reactor loading hopper 310. While FIG. 3B shows three feed hoppers 312, one of ordinary skill in the art with the benefit of this disclosure will recognize that any number of feed hoppers 312 may be used. The fluid connection between one or more feed hoppers 312 and reactor loading hopper 310 may be, for example, one or more screw conveyors 314. A separate screw conveyor may connect each feed hopper 312 with reactor loading hopper 310. In some embodiments, delivery from reactor loading hopper 310 to one or more reactors 320 may be controlled by one or more valves 316. One or more valves 316 may be, for example, rotary valves. In certain embodiments, each valve 316 may be connected to a different reactor 320. In certain embodiments, reactor 320 may be lined, such as with a halogen-resistant liner. Examples of such halogen resistant liners include quartz, HFO₂, or ceramic liners.

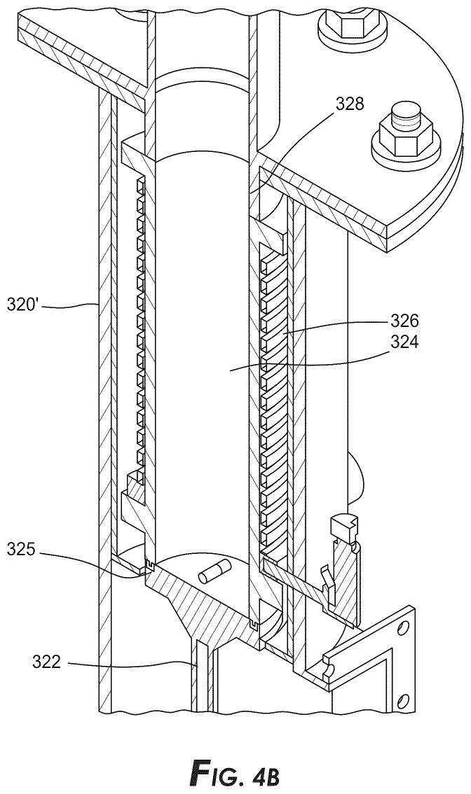

FIGS. 4A and 4B show a cutaway view of inductive heating reactor 320′. Inductive heating reactor 320′ may be a reactor used for one or more reactors 320. The inductive heating reactor 320′ may be used in a semi-batch reaction system. Inductive heating reactor 320′ may include gas inlet 322 in connection with reactor crucible 324. In gas inlet 322, the halogen and the feedstock may be combined and fluidized in the semi-batch reactor. In crucible 324, the reaction between the metal in the feedstock and halogen may take place. Induction coil 326 may be wrapped around crucible 324. In certain embodiments, inductive heating reactor 320′ may be lined, such as with a halogen-resistant liner. Examples of such halogen resistant liners include quartz, HFO₂, or ceramic liners. As current is supplied to induction coil 326, induction coil 326 supplies heat to the crucible 324 to cause the reaction. In some embodiments, diffuser 325 may be positioned at or near the bottom of crucible 324 to disperse the feedstock and halogen reactants. After reaction, the remaining halogen and the metal halide may exit inductive heating reactor 320′ through reactor gas exit 328.

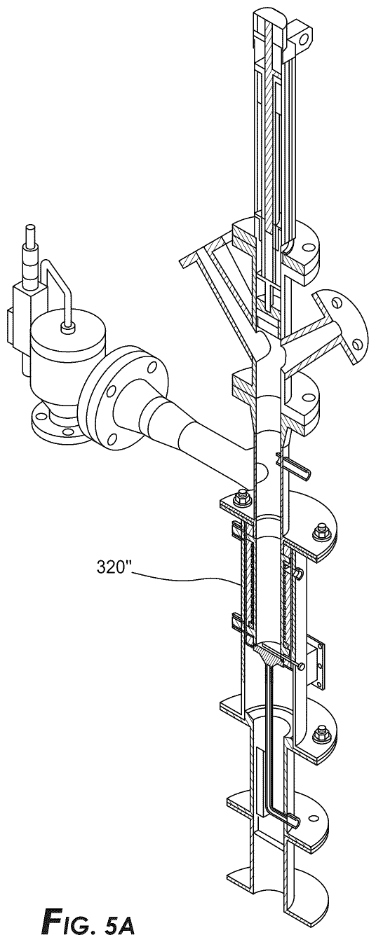

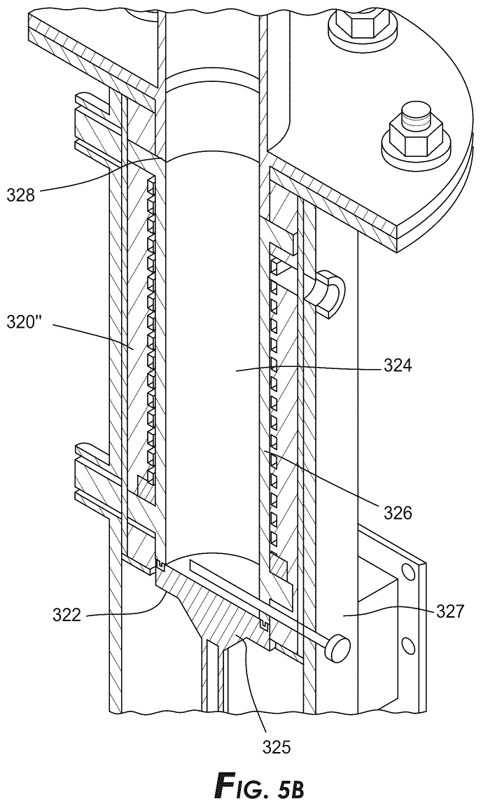

FIGS. 5A and 5B show a cutaway view of inductive/ohmic heating reactor 320″. Inductive/ohmic heating reactor 320″ may be a reactor used for one or more reactors 320. The inductive/ohmic heating reactor 320″ may be used in a semi-batch or batch reaction system. Inductive/ohmic heating reactor 320″ may include gas inlet 322 in connection with reactor crucible 324. When inductive/ohmic heating reactor 320″ is used, at least a portion of inductive/ohmic heating reactor 320″ is metal. In certain embodiments, inductive/ohmic heating reactor 320″ may be lined, such as with a halogen-resistant liner. Examples of such halogen resistant liners include quartz, HFO₂, or ceramic liners. In gas inlet 322, the halogen and the feedstock are combined and fluidized in the semi-batch reactor. In crucible 324, the reaction between the metal in the feedstock and halogen takes place. Induction coil 326 may be wrapped around crucible 324. As current is supplied to induction coil 326, induction coil 326 may supply heat to crucible 324, resulting in reaction of the halogen and the feedstock. Further, crucible 324 may be heated by passing direct current through metal portion 327 of crucible 324. In some embodiments, diffuser 325 may be positioned at or near the bottom of crucible 324 to disperse the feedstock and halogen reactants. After reaction, the remaining halogen and the metal halide may exit inductive heating reactor 320′ through reactor gas exit 328.

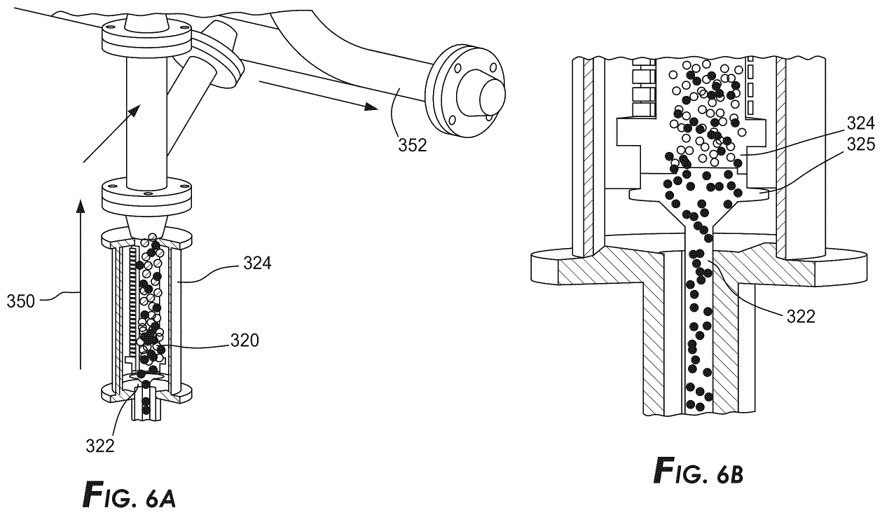

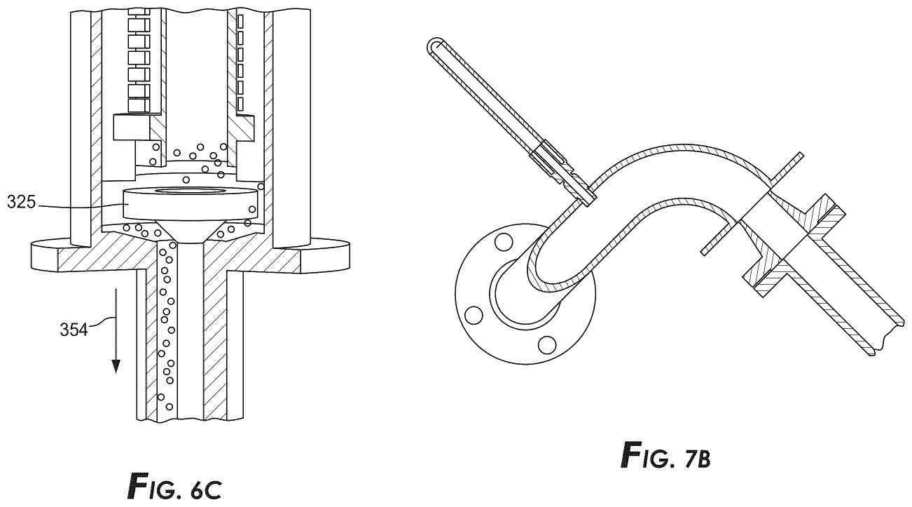

FIGS. 6A, 6B, and 6C depict process steps in the operation of reactor 320 consistent with certain embodiments of the present disclosure. In FIG. 6A, process flow 350 of halogen gas is shown through crucible 324 of reactor 320. In process flow 350, the halogen gas is fluidized, as shown in FIG. 6B by using diffuser 325, which is located at gas inlet 322 of crucible 324. During the reaction, the feedstock, which may be introduced through reactor gas exit 328, is combined with the halogen gas to form metal halides and residual chlorine gas, which exits through outgassing manifold 352, as shown in FIG. 6A. Unreacted feedstock may be discharged from reactor 320 through gas inlet 322 as depicted by discharge 354 after completion of the semi-batch reaction, as shown in FIG. 6C.

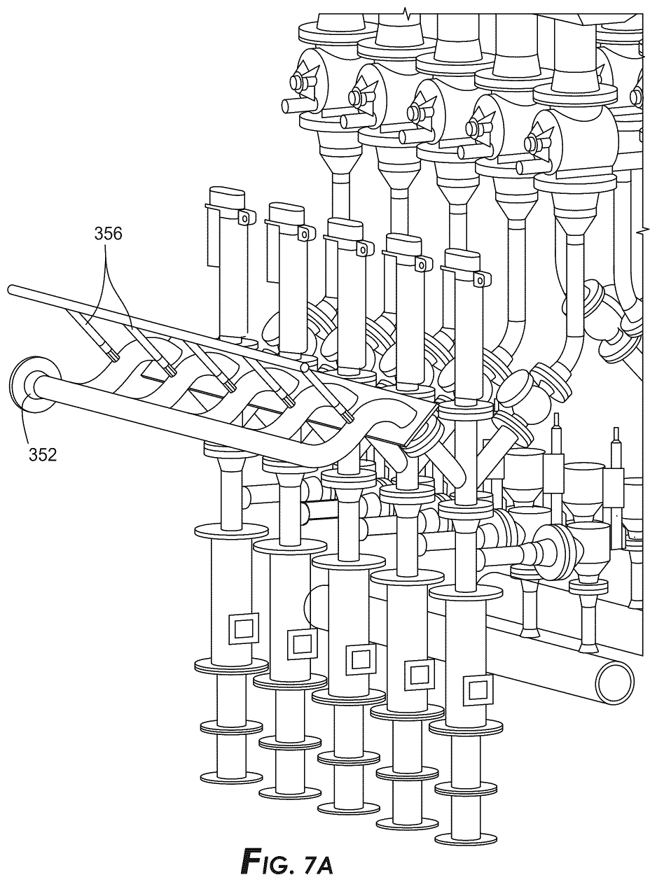

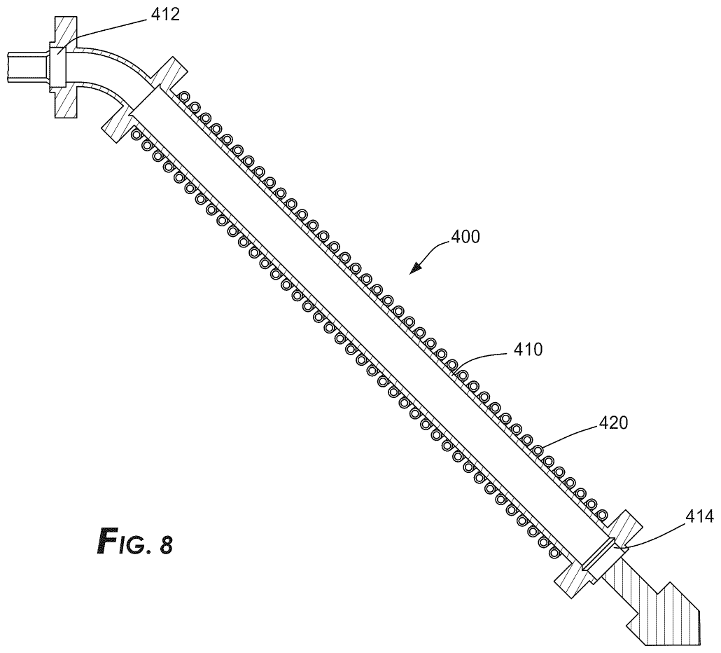

As shown in FIGS. 7A and 7B, outgassing manifold 352 may include water jets 356. Water jets 356 assist in cooling the metal halides and forming the brine.

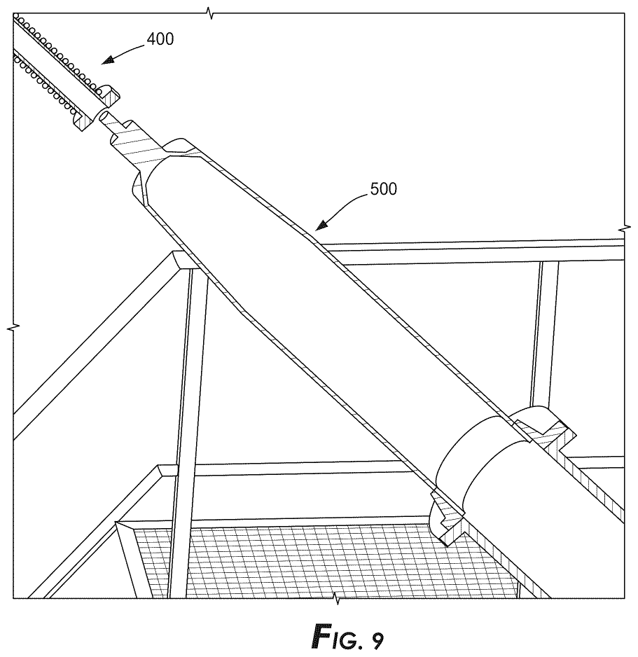

FIG. 8 depicts continuous inductive heating reactor 400 consistent with certain embodiments of the present disclosure. Continuous inductive heating reactor 400 may include reactor body 410, which may be a tube, such as that shown in FIG. 8. Wrapped about reactor body 410 may be one or more induction coils 420. Reactor body 410 may include inlet 412 and outlet 414.

FIG. 9 depicts downstream washing unit 500 in connection with continuous inductive heating reactor 400 consistent with certain embodiments of the present disclosure. In downstream washing unit 500, metal halides from continuous inductive heating reactor 400 are combined with water to form a brine. Unreacted halogen gas may be separated from the brine.

1. A metal treatment process comprising:
crushing or grinding a metal-containing feedstock; and
heating the metal-containing feedstock in an inductive heating reactor or inductive/ohmic heating reactor.

2. The metal treatment process of claim 1 further comprising after heating the metal-containing feedstock:
cooling the metal; and
recovering the metal.

3. The metal treatment process of claim 1, wherein the feedstock is electronic waste, black mass, lanthanide concentrate, spodumene, bauxite residue, coal fly ash, gold tailings, or production scrap from processes utilizing Indium, Gallium, or Germanium.

4. A metal extraction process comprising:
crushing or grinding a metal-containing feedstock;
combining the feedstock with a halogen gas; and
reacting the metal-containing feedstock in an inductive heating reactor or inductive/ohmic heating reactor to form a metal halide.

5. The metal extraction process of claim 4, wherein the feedstock is electronic waste, black mass, lanthanide concentrate, spodumene, bauxite residue, coal fly ash, gold tailings, or production scrap from processes utilizing Indium, Gallium, or Germanium.

6. The method of claim 4 further comprising prior to reacting the metal-containing feedstock:
fluidizing the feedstock using a fluidizing agent.

7. The method of claim 6, wherein the fluidizing agent is a noble gas, the halogen gas, or a combination thereof.

8. The method of claim 4 further comprising prior to reacting the metal-containing feedstock:
combining the metal-containing feedstock with a carrier fluid.

9. The method of claim 8, wherein the carrier fluid is a noble gas, the halogen gas, or a combination thereof.

10. The method of claim 4 further comprising selecting a temperature range for the inductive heating reactor or inductive/ohmic heating reactor that corresponds with a pre-selected product.

11. The method of claim 4 further comprising after the step of reacting the metal-containing feedstock;
capturing the metal halide gas.

12. The method of claim 11 further comprising washing the metal halides.

13. The method of claim 12 further comprising condensing the metal halides.

14. A semi-batch reaction system comprising;
a reactor loading hopper;
one or more inductive heating reactors or inductive/ohmic heating reactors in fluid connection with the reactor loading hopper;
an outgassing manifold, the outgassing manifold in fluid connection with the one or more inductive heating reactors or inductive/ohmic heating reactors.

15. The semi-batch reaction system of claim 14 further comprising one or more feed hoppers in fluid connection with the reactor loading hopper.

16. The semi-batch reaction system of claim 15, wherein the fluid connection between the feed hoppers and the reactor loading hopper is a screw conveyor.

17. The semi-batch reaction system of claim 14, wherein the fluid connection between the reactor loading hopper and the one or more inductive heating reactors or inductive/ohmic heating reactors is a rotary valve.

18. The semi-batch reaction system of claim 14, wherein the outgassing manifold includes one or more spray jets.

19. The semi-batch reaction system of claim 14, wherein an inductive heating reactor is used and the inductive heating reactor includes a crucible and an induction coil wound around the crucible.

20. The semi-batch reaction system of claim 14, wherein an inductive/ohmic heating reactor is used and the inductive heating reactor includes a crucible and an induction coil wound around the crucible and at least a portion of the crucible is made of metal.
